(19) United States
(12) Patent Application Publication
(10) Pub. No.: US 2012/0287823 A1
(43) Pub. Date: Nov. 15, 2012

(54) VERIFICATION METHOD AND SYSTEM FOR SCREENING INTERNET CALLER ID SPOOFS AND MALICIOUS PHONE CALLS

(76) Inventor: Chung-Yu LIN, Kaohsiung City (TW)

(21) Appl. No.: 13/466,553

(22) Filed: May 8, 2012

Related U.S. Application Data
(60) Provisional application No. 61/483,801, filed on May 9, 2011.

(51) Int. Cl. H04L 12/16

(52) U.S. Cl. 370/259

(57) ABSTRACT

A verification system for screening internet caller ID spoofs and malicious phone calls includes a server, a register interface, a capturing interface, a searching and comparing software, a searching database, a caller ID database of failed-verification telephone numbers, and marking indication software. The searching database stores a telephone number of caller ID and configured data of telephone number of every internet user. The searching and comparing software compares the telephone number of caller ID and configured data of caller ID included in the internet calling signal with a corresponding telephone number and configured data of the telephone number stored in the searching database. The marking indication software sends a verified result of the comparison with a corresponding indication signal to a target receiving callee so that the callee can easily take suitable measures to prevent becoming the victim of telephone fraud.

This application claims the benefit of provisional U.S. Patent Application No. 61/483,801, filed May 9, 2011, and incorporated herein by reference.

### FIELD OF THE PRESENT INVENTION

The present invention relates to a verification system for screening internet caller ID spoofs and malicious phone calls, in which a telephone number and configured data of a caller ID included in a internet calling signal are actively compared with a telephone number and configured data of the telephone number stored in the searching database to screen out “fraudulent phone calls,” a verified result of the comparison are sent together with a corresponding “failed verification” indication signal to a target receiving callee, and the fraudulent telephone number with related configured data are stored in a specific failed-verification database for actively screening caller ID spoofs and malicious phone calls.

### BACKGROUND OF THE INVENTION

Since about 2000, telephone fraud has greatly increased in Taiwan. Furthermore, such fraud has spread to mainland China in the last three years. As a result, total monetary loss and the number of victims of telephone fraud has consistently soared every year. In order to prevent the public from suffering telephone fraud, the superintending government agency in charge of telecommunication, the National Communications Commission of Taiwan (NCC), has issued a regulation that telecommunication companies and international Internet Service Providers (ISP) are obliged to set up authenticating and blocking mechanisms against overseas incoming telephone calls, for screening and blocking certain telephone numbers from specific caller identities. However, due to the ever-changing techniques of telephone fraud, most telephone fraudsters can easily tamper with a telephone number of the caller ID device to be displayed on the callee display screen. A gangster or syndicate can easily cheat and evade the existing authenticating and blocking mechanisms applied to incoming overseas incoming telephone calls, which have been established by the telecommunication companies and ISPs, by sending fake telephone numbers in the caller ID in order to masquerade as trustworthy entities such as a government agency, local court, regional prosecutor's office, or the like, to cause callee victims to suffer from caller ID spoofing once again. Telephone fraud is a part of the communication frauds used to deceive users by viciously exploiting the usability of current web security technologies, including the Signaling System No. 7 (SS7) telephony signaling protocol set, which is used to set up most of the world's public switched telephone network (PSTN) telephone calls. Currently, all overseas telephone transmissions carried by the telecommunication industries in every country are gradually being moved to internet for reducing transmission cost, so that the overseas telephone transmissions are blended with internet transmissions. Therefore, the regulations of the National Communications Commission of Taiwan (NCC) to establish blocking technology against international telephone fraud has been ineffective in screening and blocking certain tampered telephone numbers of fraudsters, who use fake caller-ID data to give the appearance that calls come from overseas, such as Mainland China, while actually having a domestic origination in Taiwan. However, efforts at blocking technology have so far failed as a result of the following problems:

1. Invalid Filtering:

Because caller ID telephone numbers can easily be tampered with via current web technologies to allow caller ID spoofing by the fraudsters, the telephone fraud gangster or syndicate can effortlessly cheat and evade existing authenticating and blocking mechanisms against incoming telephone calls set up by the telecommunication companies and ISPs by arbitrarily changing the telephone number of the caller ID.

2. Undue Blocking:

Because the existing authenticating and blocking mechanism against incoming telephone calls set up by the telecommunication companies and ISP directly blocks any doubtful telephone call from any suspicious caller ID, some legal telephone calls might be wrongly blocked due to lack of a caller telephone number or an incomplete caller telephone number due to lack of a country code or the like, which might be misjudged as a fraudulent phone call so that it is improperly hindered.

3. Industry Protest:

As a result of the foregoing “undue blocking,” some harmful effects may subsequently be incurred. First, the number of customer complaints is increased, resulting in goodwill damage and escalation of customer service costs. Second, annual revenue of telephone transmissions is decreased. Accordingly, the telecommunication companies and ISPs have no incentive to enthusiastically cooperate with the National Communications Commission of Taiwan (NCC) and are reluctant to comply with the foregoing regulation stipulated by the National Communications Commission Taiwan (NCC).

4. Public Confusion:

For efficiency in preventing telephone fraud, comprehensive blocking of all doubtful telephone calls from any suspicious caller ID is the most effective way. However, the inconvenience of communication incurred by the above-mentioned “undue blocking” will disturb legitimate callers and callees alike. Contrarily, the good intention of the government in urging the telecommunication companies and ISPs to prevent telephone fraud easily becomes a source of people's grievances.

Accordingly, since telephone fraudsters continue to be equipped with internet and cyber techniques for tampering with caller ID telephone numbers by masquerading as a trustworthy entity or government agency, the ordinary callee is unable to authenticate whether an incoming telephone call is genuine or a sham. Therefore, there is an urgent need for an effective verification method and system for screening internet caller ID spoofs and malicious phone calls without any of the unfavorable issues mentioned above, so that the telecommunication companies and ISPs will be happy and willing to implement the system and method to practically prevent telephone fraud.

U.S. patent application Ser. No. 11/699,330 (Publication number US2008/0181379) entitled “Caller Name Authentication to Prevent Caller Identity Spoofing” discloses a solution to the ID spoofing problem that involves use of a separate caller name authentication mechanism to perform user name verification. However, this authentication mechanism requires triple redundant means i.e., to implement the authentication mechanism, a telecommunication company and ISP must set up an extra authentication system in addition to the existing telecommunication facility; the telecommunication user is required to set up an extra auxiliary authentication device in addition to the existing telephone facility; and, in practice, an extra auxiliary authentication channel must be set up in addition in addition to the existing telecommunication channel. This results in extra economical costs, and problems with system compatibility and communication efficiency, with the result that the chance of adoption is unfavorable.

Therefore, there is still a need for an effective verification method and system for screening internet caller ID spoofs and malicious phone calls, which can be constructed using existing telecommunication facility infrastructure, that does not require an extra auxiliary device to be set up in addition to the existing telephone facility for the user, and that also does not require an extra auxiliary channel to be set up in addition to the existing telecommunication channel, thereby providing a favorable economical effect, system compatibility, and communication efficiency, to overcome a critical demand for practically preventing telephone fraud.

### SUMMARY OF THE INVENTION

The present invention is a “verification method and system for screening internet caller ID spoofs and malicious phone calls. The system of the invention, according to preferred exemplary embodiments of the invention, includes a screening verification system with a server, a register interface, a capturing interface, a searching and comparing software, a searching database, a caller ID database of failed-verification telephone numbers, and marking indication software. The method of the invention, according to preferred exemplary embodiments, includes the following steps:

a. Instruct each internet calling user to access the screening verification system via the Internet or telecommunication network to input his/her telephone number and his/her configured data of telephone number into the screening verification system through a register interface;

b. The telephone number and configured data of telephone number input in the register interface is immediately processed by a verification procedure for telephone number in right-of-use, then jointly stored in the searching database embedded in the server of the verification system;

c. Through the Internet or telecommunication network, a internet calling device issues a internet calling signal to the capturing interface in the verification system for extracting the telephone number of caller ID and configured data of caller ID included in the internet calling signal, and via the searching and comparing software in the verification system, both the telephone number of caller ID and configured data of caller ID included in the internet calling signal are relayed to the searching database for comparison with the telephone number and configured data of telephone number stored therein; and

d. If any discrepancy between the telephone number, configured data of telephone number in the searching database and the caller ID, configured data of the caller ID included in the internet calling signal is found during the comparison, the marking indication software sends the screened telephone number of the caller ID included in the internet calling signal with a corresponding “failed verification” indication signal to a target receiving callee by displaying the screened telephone number and a failed verification indication in a telephone number display field on a callee receiving device, and stores the telephone number of caller ID and configured data of caller ID included in the internet calling signal that failed verification into the caller ID database of failed-verification telephone numbers for statistical analysis in the future so that the dynamic state of internet caller ID spoofs and malicious phone calls can be effectively monitored in a well regulated manner. Conversely, if no discrepancy during the identity comparison is found, the marking indication software sends the screened telephone number of caller ID included in the internet calling signal with a corresponding “successful verification” indication signal to the target receiving callee for displaying in the telephone number display field on the callee receiving device so that the receiving callee can feel safe to receive the telephone call after visually checking the display of the telephone number. Thus, the receiving callee can easily authenticate whether a genuine or sham incoming telephone number is being displayed on the caller ID for further detecting fake caller IDs and effectively reducing fraudulent telephone calls.

The verification method and system for screening internet caller ID spoofs and malicious phone calls can effectively obviate invalid filtering and undue blocking issues. To overcome invalid filtering issues, use of dual screening verification of the telephone number and configured data of the caller ID included in the internet calling signal can substantially prevent caller ID spoofing frauds. To reduce undue blocking, the unjustified “fraudulent telephone” can still be sent with a corresponding “failed verification” indication signal, and connected to the target receiving callee instead of being blocked even though it failed the screening verification of the present invention, so that the telecommunication company can still charge the caller without negatively affecting operation revenue. Therefore, public confusion resulting from invalid filtering and industry protest due to undue blocking can be completely obviated. Thus, features of the present invention not only can effectively prevent the crime of “telephone fraud” but also can obviate negatively reluctant attitudes against complying with anti-phone-fraud regulations.

The present invention verification method and system for screening internet caller ID spoofs and malicious phone calls also provides benefits of simple and easy installation because the verification method and system for screening internet caller ID spoofs and malicious phone calls of the present invention is constructed on the infrastructure of the existing telecommunication facility, such that no extra auxiliary device is required to be set up in addition to an existing telephone facility for the user, and no extra auxiliary channel is required to be set up in addition to an existing telecommunication channel in practical usage, and that provides a favorable economical effect, system compatibility and communication efficiency.

### BRIEF DESCRIPTION OF THE DRAWINGS

FIG. 1 is a flowchart of processing steps for a preferred exemplary embodiment of the present invention.

FIG. 2 is a first systematic processing block diagram of functional connections for a preferred exemplary embodiment of the present invention.

FIG. 3 is a second systematic processing block diagram of functional connections for another preferred exemplary embodiment of the present invention.

FIG. 4 is a syntax example of a virtual calling signal of a Session Initiation Protocol (SIP) used in internet communication sessions for a preferred exemplary embodiment of the present invention.

### DETAILED DESCRIPTION OF THE PREFERRED EMBODIMENTS

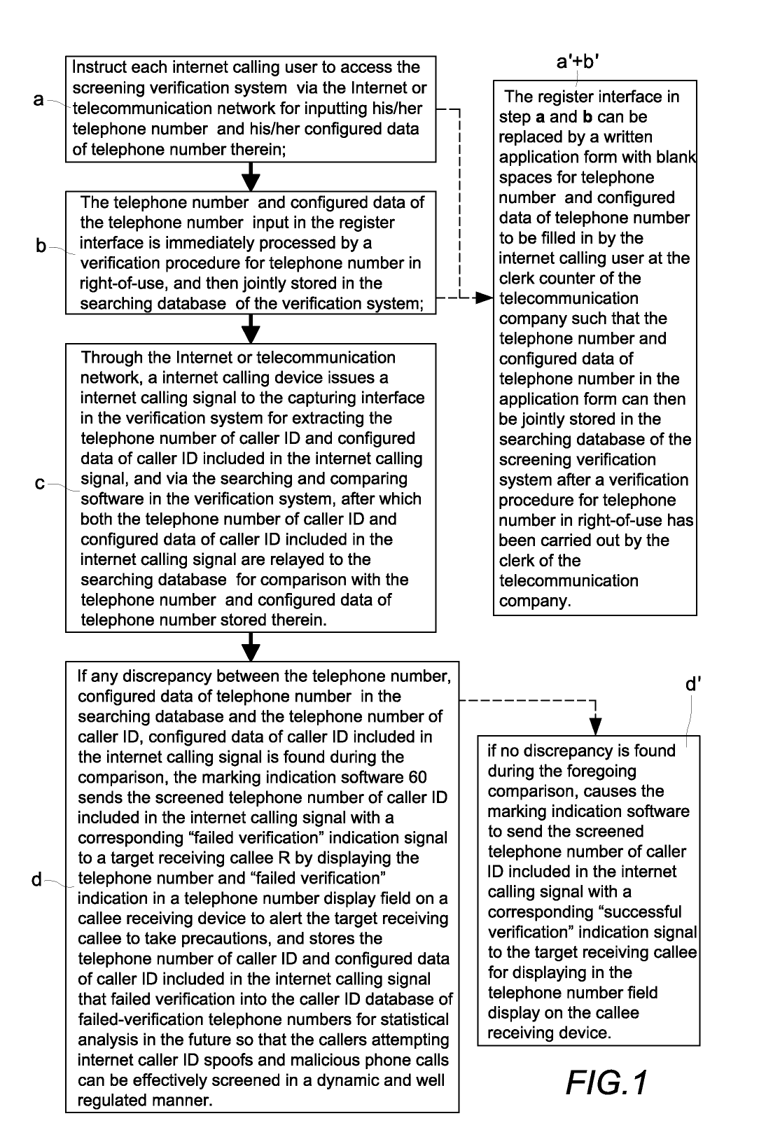

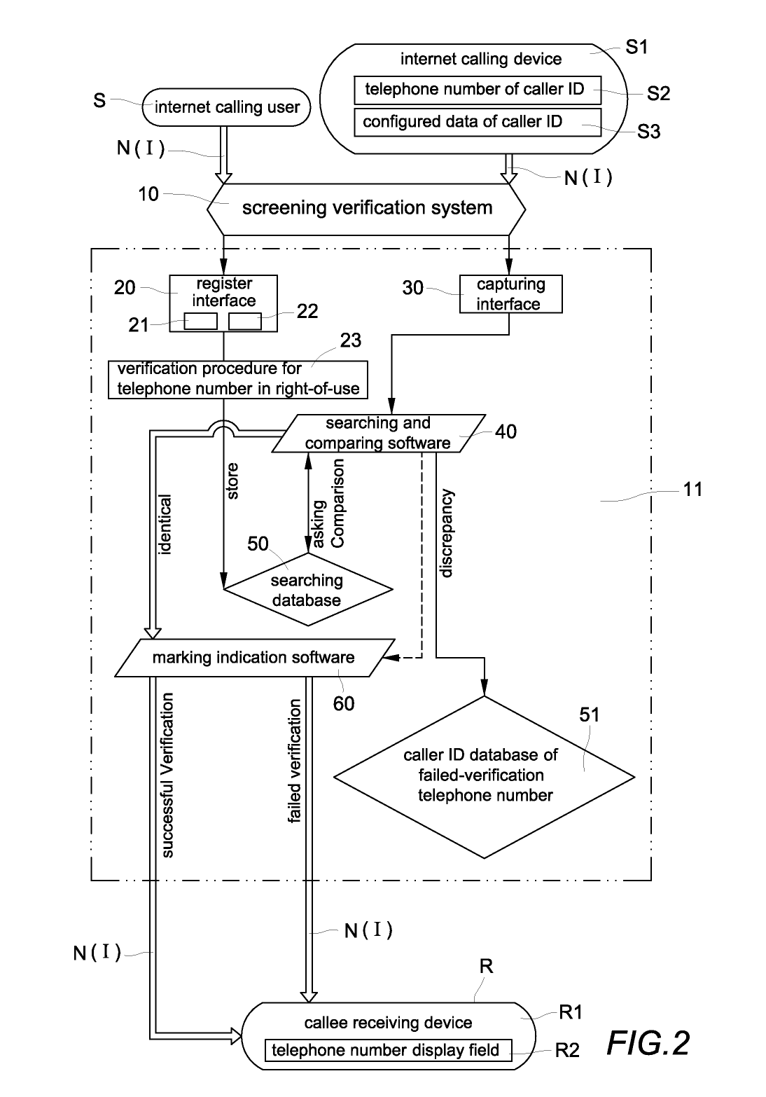

Please refer to FIGS. 1 and 2, which are a flowchart of the processing steps and a systematic processing block diagram of a preferred exemplary embodiment of a verification method and system for screening internet caller ID spoofs and malicious phone calls of the present invention. The verification system for screening internet caller ID spoofs and malicious phone calls” includes a screening verification system 10, a register interface 20, a capturing interface 30, a searching and comparing software 40, a searching database 50, a caller ID database of failed-verification telephone numbers 51 and a marking indication software 60. A preferred verification method for screening internet caller ID spoofs and malicious phone calls is implemented on the system of FIG. 2 and includes the following processing steps:

a. Instruct each internet calling user S to access the screening verification system 10 via the Internet I or telecommunication network N for inputting his/her telephone number 21 and his/her configured data of telephone number 22 therein;

b. The telephone number 21 and configured data of the telephone number 22 input in the register interface 20 is immediately processed by a verification procedure for telephone number in right-of-use 23, and then jointly stored in the searching database 50 of the verification system 10;

c. Through the Internet I or telecommunication network N, a internet calling device S1 issues a internet calling signal to the capturing interface 30 in the verification system 10 for extracting the telephone number of caller ID S2 and configured data of caller ID S3 included in the internet calling signal, and via the searching and comparing software 40 in the verification system 10, after which both the telephone number of caller ID S2 and configured data of caller ID S3 included in the internet calling signal are relayed to the searching database 50 for comparison with the telephone number 21 and configured data of telephone number 22 stored therein; and

d. If any discrepancy between the telephone number 21, configured data of telephone number 22 in the searching database 50 and the telephone number of caller ID S2, configured data of caller ID S3 included in the internet calling signal is found during the comparison, the marking indication software 60 sends the screened telephone number of caller ID S2 included in the internet calling signal with a corresponding “failed verification” indication signal to a target receiving callee R by displaying the telephone number and “failed verification” indication in a telephone number display field R2 on a callee receiving device R1 to alert the target receiving callee R to take precautions, and stores the telephone number of caller ID S2 and configured data of caller ID S3 included in the internet calling signal that failed verification into the caller ID database of failed-verification telephone numbers 51 for statistical analysis in the future so that the callers attempting internet caller ID spoofs and malicious phone calls can be effectively screened in a dynamic and well regulated manner.

Step d further includes a sub-step d′ that, if no discrepancy is found during the foregoing comparison, causes the marking indication software 60 to send the screened telephone number of caller ID S2 included in the internet calling signal with a corresponding “successful verification” indication signal to the target receiving callee R for displaying in the telephone number display field R2 on the callee receiving device R1 so that the receiving callee R can feel safe to receive the telephone call after visual checking of the telephone number display field R2.

Step d further includes a sub-step d″ that, if no discrepancy between the configured data of telephone number 22 in the searching database 50 and configured data of caller ID S3 included in the internet calling signal is found during the foregoing comparison, but a discrepancy between the telephone number 21 in the searching database 50 and telephone number of caller ID S2 included in the internet calling signal is found, causes the marking indication software 60 to send the telephone number of caller ID S2 included in the internet calling signal with a corresponding “failed verification” indication signal together with the telephone number 21 corresponding to the matched configured data of telephone number 22 stored in the searching database 50 to the target receiving callee R for displaying in the telephone number display field R2 on the callee receiving device R1 so that the receiving callee R can obtain the genuine telephone number of the caller prior to receiving the telephone call after visual checking of the telephone number display filed R2.

In all foregoing steps, the telephone number 21 denotes a telephone number of a local fixed-line system or cellular system while the configured data of telephone number 22 is preset by each internet calling user S.

The register interface 20 in step a can be replaced by a written application form with blank spaces for telephone number 21 and configured data of telephone number 22 to be filled in by the internet calling user S at the clerk counter of the telecommunication company such that the telephone number 21 and configured data of telephone number 22 in the application form can then be jointly stored in the searching database 50 of the screening verification system 10 after a verification procedure for telephone number in right-of-use 23 has been carried out by the clerk of the telecommunication company. Furthermore, the registration of the register interface 20 in step a can also be finished by input via a proprietary direct-dial voice line, fixed-line or value-added mobile website.

Furthermore, the telecommunication network N of steps a and c may include a PSTN (Public Switched Telephone Network) used in a fixed-line telephone system, a GSM system (Global System for Mobile Communications) used in a cellular telephone system, a TDMA system (Time Division Multiple Access), a CDMA system (Code Division Multiple Access), a PDC system (Personal Digital Cellular) and various telecommunication networks mutually connected with the Internet I. As a result, any call via the Internet I can also be performed via telecommunication network N to achieve duplex transmission between the internet calling user S and receiving callee R.

Accordingly, a telephone fraudster is unable to get the correct configured data of telephone number 22 of the internet calling user S even if he/she is able to create a fake telephone number 21. Any calling telephone via the Internet I will be directly linked to the capturing interface 30 by the telecommunication network N, and indirectly relayed to the searching database 50 of the screening verification system 10 for comparison. The joint data of the fake telephone number 21 without a correct configured data of telephone number 22 issued by the telephone fraudster will fail the identity comparison so that the marking indication software 60 will automatically send the screened telephone number of caller ID S2 included in the internet calling signal together with a corresponding “failed verification” alert indication signal to the target receiving callee R for displaying on the telephone number display field R2 of a callee receiving device R1. Thus, the receiving callee R can easily judge that the incoming telephone number of the caller is a “fraudulent telephone” by visual checking of the telephone number display field R2, with no need to take the trouble to ask for confirmation via a proprietary anti-fraud phone number 165 and criminal case-report phone number 110 set by the government. As a result, the crime of telephone fraud can be timely and effectively stopped. Meanwhile, the “fraudulent telephone” can still be connected with the target receiving callee R instead of being blocked, even though it failed screening verification so that the telecommunication company can still charge the caller without risk of undue blocking. Thus, promotion of the present invention not only can effectively prevent the crime of “telephone fraud” but also can eliminate reluctance to comply with anti-phone-fraud regulation.

Please refer to FIG. 2, which is a systematic processing block diagram for a preferred exemplary embodiment of the verification method and system for screening internet caller ID spoofs and malicious phone calls of the present invention that includes a screening verification system 10 with a server 11, in which the screening verification system 10 functions to govern and coordinate overall operations of an associated server 11 and all data elements included therein. Server 11 is connected with the Internet I to provide essential services across a network, either to private users inside a large organization or to public users via the Internet such that all input and output data thereof comply with various protocols of the Internet I, and includes a register interface 20, a capturing interface 30, a searching and comparing software 40, a searching database 50, a caller ID database of failed-verification telephone numbers 51 and marking indication software 60 therein Furthermore, the verification method of FIG. 2 includes the following steps:

The register interface 20, which is disposed in the server 11 of the screening verification system 10, provides the fields of telephone number 21 and configured data of telephone number 22 for input by any internet calling user S, after which the telephone number 21 and configured data of telephone number 22 are jointly relayed to the searching database 50;

Capturing interface 30, which is disposed in the server 11 of the screening verification system 10, extracts a telephone number of caller ID S2 included in internet calling signal and configured data of caller ID S3 included in internet calling signal out of a internet calling signal issued from a internet calling device S1 and then relays them to the searching and comparing software 40;

Searching and comparing software 40, which is disposed in the server 11 of the screening verification system 10, compares the joint data of telephone number of caller ID S2 and configured data of caller ID S3 included in the internet calling signal relayed from the capturing interface 30 with corresponding joint data of telephone number 21 and configured data of telephone number 22 stored in the searching database 50;

Searching database 50, which is disposed in the server 11 of the screening verification system 10, stores the joint data of telephone number 21 and configured data of telephone number 22 of every internet calling user S relayed from the register interface 20;

Marking indication software 60, which is disposed in the server 11 of the screening verification system 10, obtains the verified result of the foregoing comparison of the joint data of telephone number of caller ID S2 and configured data of caller ID S3 included in the internet calling signal with corresponding joint data of telephone number 21 and configured data of telephone number 22 for sending with a corresponding indication signal to a target receiving callee R, and stores in the caller ID database of failed-verification telephone numbers 51 which the joint data of each telephone number of caller ID S2 and configured data of caller ID S3 included in the internet calling signal that fails verification by comparison; and

The caller ID database of failed-verification telephone numbers 51, which is disposed in the server 11 of the screening verification system 10, stores all joint data of the telephone number of caller ID S2 and configured data of caller ID S3 included in the internet calling signal that has failed verification for statistical analysis in the future so that the dynamic state of callers attempting internet caller ID spoofs and malicious phone calls can be effectively screened and regulated.

The marking indication software 60 can be obtained by download via the Internet I or directly built-in by a manufacturer, and can be embedded in a callee receiving device R1 of every receiving callee R instead of being disposed in the server 11 of the screening verification system 10. Moreover, the corresponding indication signal sent by the marking indication software 60 can be arbitrarily selected from various options of a character, symbol, audio or video for output so that handicapped people such as blind people, mute people or the like can perceive and understand the corresponding indication signal.

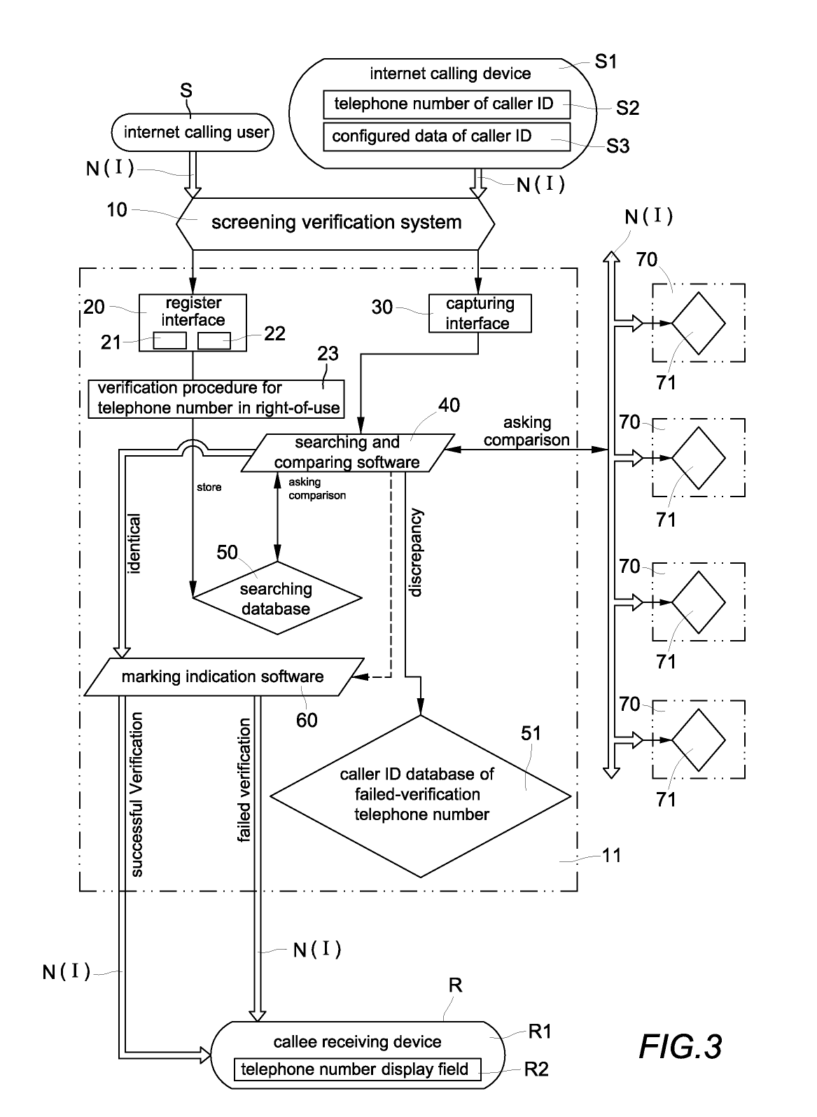

Please refer to FIG. 3, which is a second systematic processing block diagram of functional connections in another preferred exemplary embodiment of a verification method and system for screening internet caller ID spoofs and malicious phone calls of the present invention. The verification system for screening internet caller ID spoofs and malicious phone calls further includes, in addition to the existing screening verification system 10, a plurality of external screening verification systems 70 connected to the Internet I such that each screening verification system 70 includes a searching database 71 embedded in a respective internal server Each searching database 71, which is included in the existing searching database 50 of the screening verification system 10 via connection to the Internet I, also respectively stores all the joint data of a telephone number 21 and configured data of telephone number 22 of every internet calling user S in duplicate.

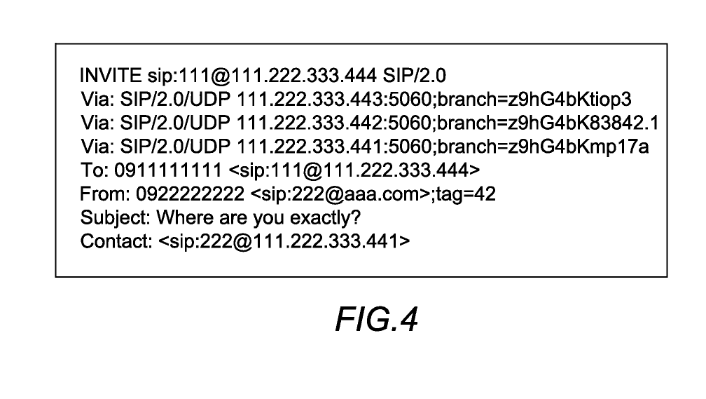

Please refer to FIG. 4, which is a syntax example of a virtual calling signal of Session Initiation Protocol (SIP) used in internet communication sessions in a preferred exemplary embodiment of the verification method and system for screening internet caller ID spoofs and malicious phone calls of the present invention. The data “0922222222” in the field “From” of line 6 refers to a position of a telephone number of caller ID S2 included in internet calling signal, which is to be extracted by the capturing interface 30 of the present invention, and a position of the telephone number display field R2 in the callee receiving device R1, which is to be sent by the marking indication software 60 of the present invention. The data “111.222.333.442” in the field “Via” of line 3 denotes an address for the server of the Session Initiation Protocol (SIP) while the data “111.222.333.441” in the field “Via” of line 4 denotes an address for the terminal device of the Session Initiation Protocol (SIP), and the data “222” in the field “Contact” of line 8 denotes a caller ID of the Session Initiation Protocol (SIP), all of the foregoing three types of data combine to jointly refer to a common position of configured data of caller ID S3 included in internet calling signal, which is also to be extracted by the capturing interface 30 of the present invention. The data in the field “From” of line 6 may be easily tampered with by a malicious caller, but the data in the field “Via” of line 4 referring to an address for the terminal device of the Session Initiation Protocol (SIP) and the data in the field “Contact” of line 8 referring to a caller ID of the Session Initiation Protocol (SIP) are unable to be arbitrarily changed. Once the screening verification system 10 is initiated, the capturing interface 30 will first extract a corresponding telephone number of caller ID S2 included in internet calling signal in accordance with the data in the field “From” of line 6, and a corresponding configured data of caller ID S3 included in internet calling signal in accordance with the joint data combining the data in the field “Contact” of line 8 and the data in the field “Via” of line 3 or the data in the field “Via” of line 4. Second, the joint data of the telephone number of caller ID S2 and the configured data of caller ID S3 included in internet calling signal will be sent to the searching and comparing software 40 for comparison to obtain a verification result with a corresponding indication signal. Third, the marking indication software 60 will send the verification result with the corresponding indication signal to the telephone number display field R2 in the target callee receiving device R1 for displaying the corresponding indication signal in accordance with the data in the field “From” of line 6. Finally, if the result of the screening verification is “failed verification”, the searching and comparing software 40 will store in the caller ID database of failed-verification telephone numbers 51 the joint data of the telephone number of caller ID S2 and configured data of caller ID S3 included in the internet calling signal that failed verification.

In summary, in order to counteract telephone fraud by caller ID spoofing involving arbitrarily tampering with the telephone number of the caller ID included in internet calling signal, the present invention provides additional screening verification on the configured data of the caller ID included in internet calling signal to authenticate whether the telephone number of caller ID included in internet calling signal of the caller ID is genuine or a sham, and marking “failed verification” on telephone numbers that fail verification. Thus, not only can internet caller ID spoofs and malicious phone calls from telephone fraud gangsters or syndicates be effectively countered, but also the disadvantageous loopholes in existing authenticating and blocking mechanisms against overseas incoming telephone calls set up by the telecommunication company and/or international ISP are closed. Moreover, the verification method and system for screening internet caller ID spoofs and malicious phone calls of the present invention is constructed on infrastructure of an existing telecommunications facility such that no extra auxiliary device is required to be set up in addition to the existing telephone facility of the user, and no extra auxiliary channel is required to be set up in addition to the existing telecommunication channel in practical usage, resulting in favorably considered economic effect, system compatibility and communication efficiency. Accordingly, we submit the patent application for the present invention in accordance with related patent laws as it meets essential criterion of patentability.

1. A verification method for screening internet caller ID spoofs and malicious phone calls in association with a system that includes a screening verification system with a server, a register interface, a capturing interface, a searching and comparing software, a searching database, a caller ID database of failed-verification telephone numbers that fail verification, and a marking indication software, comprising the following steps:
a. instruct each internet calling user to access the screening verification system via the Internet or a telecommunications network for inputting his/her telephone number and his/her configured data of telephone number therein via a register interface;
b. the telephone number and configured data of telephone number input via the register interface is processed by a verification procedure for telephone number in right-of-use, and then jointly stored in the searching database of the verification system;
c. through the Internet or a telecommunication network, a internet calling device issues a internet calling signal to the capturing interface in the verification system for extracting a telephone number of caller ID and configured data of caller ID included in the internet calling signal, and via the searching and comparing software in the verification system, after which both the telephone number of caller ID and configured data of caller ID included in the internet calling signal are relayed to the searching database for comparison with the telephone number and configured data of telephone number stored therein; and
d. if any discrepancy between the telephone number, configured data of telephone number in the searching database and the telephone number of caller ID, configured data of caller ID included in the internet calling signal is found during said comparison, the marking indication software sends the screened telephone number of caller ID included in the internet calling signal with a corresponding “failed verification” indication signal to a target receiving callee by displaying the telephone number and “failed verification” indication in a telephone number display field on a callee receiving device to alert the target receiving callee to take precautions, and stores the telephone number of caller ID and configured data of caller ID included in the internet calling signal that failed verification into the caller ID database of failed-verification telephone numbers for statistical analysis in the future so that the callers attempting internet caller ID spoofs and malicious phone calls can be effectively and dynamically screened and regulated.

2. The verification method for screening internet caller ID spoofs and malicious phone calls as recited in claim 1, wherein step d further comprises a sub-step d′ in which, if no discrepancy in foregoing identical comparison is found, the marking indication software sends the telephone number of caller ID included in the internet calling signal with a corresponding “successful verification” indication signal to the target receiving callee for displaying in the telephone number display field on the callee receiving device.

3. The verification method for screening internet caller ID spoofs and malicious phone calls as recited in claim 1, wherein step d further comprises a sub-step d″ in which, if no discrepancy between the configured data of telephone number in the searching database and configured data of the telephone number of caller ID included in the internet calling signal is found during the comparison, while a discrepancy between the telephone number in the searching database and the telephone number of caller ID included in the internet calling signal is found, the marking indication software sends the telephone number of caller ID included in the internet calling signal with a corresponding “failed verification” indication signal together with the telephone number corresponding to the matched configured data of telephone number stored in the searching database to the target receiving callee for displaying in the telephone number display field on the callee receiving device.

4. The verification method for screening internet caller ID spoofs and malicious phone calls as recited in claim 1, wherein the telephone number in steps a, b, c and d is a telephone number of a local fixed-line system, a telephone number of a cellular system or a telephone number of a internet call.

5. The verification method for screening internet caller ID spoofs and malicious phone calls as recited in claim 1, wherein the configured data of the caller ID included in the internet calling signal of steps a, b, c and d include at least one of an address of the internet calling device, a caller ID of the internet calling device, an address for a server of the internet calling device, or a communication port of the internet calling device and other internet configured data that enable the internet calling device to successfully send and receive data.

6. The verification method for screening internet caller ID spoofs and malicious phone calls as recited in claim 1, wherein the register interface in steps a and b is replaced by a written application form with blank spaces for a telephone number and configured data of telephone number to be filled in by a internet calling user at a clerk counter of a telecommunication company, and wherein the telephone number and configured data of the telephone number filled into the application form is then jointly stored in the searching database of the screening verification system after having processed by the verification procedure for telephone number in right-of-use by the clerk of the telecommunication company.

7. The verification method for screening internet caller ID spoofs and malicious phone calls as recited in claim 1, wherein the verification procedure for telephone number right-of-use in step b is performed via a calling mechanism or receiving mechanism for telecommunication signals from a related telecommunication device corresponding to the telephone number.

8. The verification method for screening internet caller ID spoofs and malicious phone calls as recited in claim 1, wherein the internet calling signal in steps c and d is an audio, a video, an image, a character or a symbol communication signal.

9. The verification method for screening internet caller ID spoofs and malicious phone calls as recited in claim 1, wherein the telecommunication network in steps a and c includes one of a PSTN (Public Switched Telephone Network) used in a fixed-line telephone system, a GSM system (Global System for Mobile Communications) used in a cellular telephone system, a TDMA system (Time Division Multiple Access), a CDMA system (Code Division Multiple Access), a PDC system (Personal Digital Cellular) and various telecommunication networks mutually connected with the Internet respectively.

10. A verification system for screening internet caller ID spoofs and malicious phone calls, comprising a server connected with the Internet such that all input and output data thereof comply with various protocols of the Internet, wherein the server includes a register interface, a capturing interface, a searching and comparing software, a searching database, a caller ID database of failed-verification telephone numbers, and a marking indication software, and wherein:
the register interface, which is disposed in the server of the screening verification system, provides fields for input by a internet calling user of a telephone number and configured data of telephone number, the telephone number and configured data of telephone number being jointly relayed to the searching database;
the capturing interface, which is disposed in the server of the screening verification system, extracts a telephone number of caller ID and configured data of caller ID included in a internet calling signal issued from a internet calling device and then relays them to the searching and comparing software;
the searching and comparing software, which is disposed in the server of the screening verification system, compares the joint data of the telephone number of caller ID and configured data of caller ID included in the internet calling signal relayed from the capturing interface with corresponding joint data of the telephone number and configured data of telephone number stored in the searching database;
the searching database, which is disposed in the server of the screening verification system, stores the joint data of the telephone number and configured data of telephone number of every internet calling user relayed from the register interface;
the caller ID database of failed-verification telephone numbers, which is disposed in the server of the screening verification system, stores all joint data of the telephone numbers and configured data of said any caller ID included in the internet calling signal that has fails verification for statistical analysis in the future so that internet caller ID spoofs and malicious phone calls can be effectively and dynamically screened and regulated; and
the marking indication software, which is disposed in the server of the screening verification system, obtains the verified result of the comparison of the joint data of the telephone number and configured data of caller ID included in the internet calling signal with corresponding joint data of the telephone number and configured data of telephone number in the searching database for sending together with a corresponding indication signal to a target receiving callee, and stores in the caller ID database of failed-verification telephone numbers and configured data of any caller ID included in the internet calling signal that fails verification.

11. The verification system for screening internet caller ID spoofs and malicious phone calls as recited in claim 10, wherein the marking indication software is embedded in a callee receiving device of every receiving callee instead of being disposed in the server of the screening verification system, and the marking indication software is obtained by download via the Internet or directly built-in by a manufacturer.

12. The verification system for screening internet caller ID spoofs and malicious phone calls as recited in claim 10, wherein the caller ID database of failed-verification telephone numbers is further disposed in another external server, which is associated with a corresponding external screening verification system via connection to the Internet.

13. An SIP screening verification system for screening internet caller ID spoofs and malicious phone calls with application to a Session Initiation Protocol (SIP), comprising an SIP screening verification server connected with the Internet such that all input and output data thereof comply with various protocols of the Internet, the SIP screening verification server including a register interface, a data capturing interface, a data searching software, a data searching database, a caller ID database of failed-verification telephone numbers, and a marking indication software, and wherein:
the register interface, which is disposed in the server of the SIP screening verification system, provides fields for input of a telephone number and a SIP configured data of telephone number by any internet calling user, the telephone number and SIP configured data of telephone number being jointly relayed to the searching database;
the capturing interface, which is disposed in the server of the SIP screening verification system, extracts a telephone number of caller ID and SIP configured data of caller ID included in a SIP internet calling signal issued from a internet calling device and then relays them to the searching and comparing software;
the searching and comparing software, which is disposed in the server of the SIP screening verification system, compare the joint data of the telephone number of caller ID and SIP configured data of caller ID included in the SIP internet calling signal relayed from the capturing interface with corresponding joint data of the telephone number and SIP configured data of telephone number stored in the searching database;
the searching database, which is disposed in the server of the SIP screening verification system, stores the joint data of the telephone number and SIP configured data of telephone number of every internet calling user relayed from the register interface;
the caller ID database of failed-verification telephone numbers, which is disposed in the server of the SIP screening verification system, stores all joint data of the telephone number and SIP configured data of said any caller ID included in the SIP internet calling signal that fails verification; and
the marking indication software, which is disposed in the server of the SIP screening verification system, obtains the verified result of the comparison of the joint data of the telephone number and SIP configured data of caller ID included in the SIP internet calling signal with corresponding joint data of the telephone number and SIP configured data of telephone number in the searching database for sending together with a corresponding indication signal to a target receiving callee, and stores the telephone number of caller ID and SIP configured data of any caller ID included in the SIP internet calling signal that fails verification into the caller ID database of failed-verification telephone numbers.

14. The SIP verification system for screening internet caller ID spoofs and malicious phone calls as recited in claim 13, wherein the SIP configured data of the telephone number stored in the search database and the SIP configured data of caller ID included in SIP internet calling signal include at least one of an address of a SIP terminal device, a caller ID of an SIP, an address for a server of an SIP, a communication port of an SIP and other Internet SIP configured data that enable the SIP device to successfully send and receive data.

15. The verification system for screening internet caller ID spoofs and malicious phone calls as recited in claim 13, wherein the SIP configured data of the caller ID included in the SIP internet calling signal is extracted from “Via” and “Contact” fields in an SIP calling signal used in internet communication sessions by the capturing interface.

16. The verification system for screening internet caller ID spoofs and malicious phone calls as recited in claim 13, wherein the telephone number of the caller ID included in the SIP internet calling signal is extracted from a “From” field in an SIP calling signal used in internet communication sessions by the capturing interface.

17. The verification system for screening internet caller ID spoofs and malicious phone calls as recited in claim 13, wherein the telephone number of the caller ID included in the SIP internet calling signal to be sent to and displayed in the telephone number display field on the callee receiving device is extracted and correspondingly marked from the “From” field in an SIP calling signal used in a internet communication sessions by the marking indication software.

18. The verification system for screening internet caller ID spoofs and malicious phone calls as recited in claim 13, wherein the failed-verification caller ID database is further disposed in another external server, which is associated with a corresponding external SIP screening verification system via connection to the Internet.
